(19) United States
(12) Patent Application Publication
(10) Pub. No.: US 2023/0015324 A1
(43) Pub. Date: Jan. 19, 2023

(54) RETRIEVAL DEVICE

(71) Applicant: NTT DOCOMO, INC., Chiyoda-ku (JP)

(72) Inventors: Hisashi KURASAWA, Chiyoda-ku (JP); Yoshinori ISODA, Chiyoda-ku (JP); Itsuki SHIBATA, Chiyoda-ku (JP); Eri MATSUO, Chiyoda-ku (JP)

(73) Assignee: NTT DOCOMO, INC., Chiyoda-ku (JP)

(21) Appl. No.: 17/777,680

(22) PCT Filed: Oct. 27, 2020
(86) PCT No.: PCT/JP2020/040298

§ 371 Date: May 18, 2022

(30) Foreign Application Priority Data
Dec. 3, 2019 (JP) 2019-218779

(51) Int. Cl. G06F 16/33; G06F 16/242

(52) U.S. Cl. CPC G06F 16/3338; G06F 16/242

(57) ABSTRACT

A retrieval device 10 includes an input unit 11 configured to receive a search query from a user, a retrieval unit 12 configured to calculate a degree of fitness between the search query and each of a plurality of pieces of retrieval target data, a query expansion unit 13 configured to generate an expanded search query, and a policy determination unit 14 configured to determine which of a first process and a second process is to be executed on the basis of the degree of fitness for each piece of the retrieval data calculated by the retrieval unit 12. The first process is presenting the retrieval target data having a high degree of fitness to the user. The second process is proposing to the user that the retrieval unit is caused to calculate the degree of fitness for each piece of the retrieval target data using the expanded search query.

### TECHNICAL FIELD

An aspect of the present invention relates to a retrieval device.

### BACKGROUND ART

Conventionally, an information retrieval technique of retrieving data that matches a user's intention (that is, data desired by a user) from a huge amount of retrieval target data to be retrieved such as text, images, moving images, and graphs has been known. In the information retrieval, the degree of fitness between a search query which is input by a user and each piece of the retrieval target data is calculated. Then, data having a high degree of fitness is output as a search result (see, for example, Non-Patent Literature 1). In addition, query expansion (see, for example, Non-Patent Literature 2) has been proposed as an information retrieval technique for more accurately finding data that matches a user's intention. For example, in relevance feedback, which is a method of query expansion, data having a high degree of fitness with an input search query is presented to a user and the user is prompted to input a fit or unfit label for each piece of data. Then, the search query is corrected on the basis of the input label, a search is performed again using the corrected search query, and data having a high degree of fitness is presented to the user. As another method of query expansion, a technique and the like of extracting words that frequently co-occur with a search query from a search log (past search query) and proposing correction of the search query on the basis of the extracted words are known.

### CITATION LIST

### Patent Literature

[Non-Patent Literature 1] Robertson, S. E., Walker, S., Jones, S., Hancock-Beaulieu, M. & Gatford, M. (1994). Okapi at TREC-3. In D. K. Hannan (ed.), TREC (p./pp. 109-126): National Institute of Standards and Technology (NIST).
[Non-Patent Literature 2] Azad, H. K., & Deepak, A. (2019). Query expansion techniques for information retrieval: a survey. Information Processing & Management, 56(5), 1698-1735.

### SUMMARY OF INVENTION

### Technical Problem

According to the query expansion described above, it may be possible to appropriately complement the search query which is input by the user and to accurately find data that matches the user's intention. However, in a case where the query expansion is executed, additional processing, the user's operations, and the like as described above are required. That is, extra steps are required compared with a case where the query expansion is not performed. For this reason, for example, when the query expansion is executed, even though data that matches the user's intention can be found by a search using only the search query which is input by the user, it takes much labor and effort (time, steps) to finally obtain the data that matches the user's intention, which leads to a decrease in the efficiency of search. On the other hand, when search results (data having a high degree of fitness) are always presented to the user before the query expansion is performed, the user performs a useless confirmation process in a case where data that matches the user's intention is not contained in the search results, which leads to a decrease in the efficiency of search.

Consequently, an aspect of the present invention is to provide a retrieval device capable of improving the efficiency of search.

### Solution to Problem

According to an aspect of the present invention, there is provided a retrieval device including an input unit configured to receive a search query from a user, a retrieval unit configured to calculate a degree of fitness between the search query and each of a plurality of pieces of retrieval target data to be retrieved which are prepared in advance, a query expansion unit configured to generate an expanded search query by adding an expanded query associated with the search query to the search query, and a policy determination unit configured to determine which of a first process and a second process is to be executed on the basis of the degree of fitness for each piece of the retrieval target data which is calculated by the retrieval unit. The first process is presenting the retrieval target data having a high degree of fitness to the user. The second process is proposing to the user that the retrieval unit is caused to calculate the degree of fitness for each piece of the retrieval target data using the expanded search query as a new search query.

In the retrieval device according to an aspect of the present invention, which of the first process of presenting retrieval target data having a high degree of fitness with the search query to the user and the second process of proposing to the user a re-search performed by the retrieval unit using the expanded search query generated by the query expansion unit is to be executed is determined on the basis of the degree of fitness for each piece of the retrieval target data which is obtained at this point of time. Therefore, according to the above retrieval device, by appropriately switching between presenting a search result at the current point of time to the user and performing the query expansion to perform a re-search, it is possible to suppress useless processing (for example, presentation of search results that do not match the user's intention or proposal of unnecessary query expansion) and to improve the efficiency of search.

### Advantageous Effects of Invention

According to an aspect of the present invention, it is possible to provide a retrieval device capable of improving the efficiency of search.

### BRIEF DESCRIPTION OF DRAWINGS

FIG. 1 is a diagram illustrating a functional configuration of a retrieval device according to an embodiment.

FIG. 2 is a diagram schematically illustrating an outline of processing of the retrieval device.

FIG. 3 is a diagram illustrating an example of a dialogue between a user and the retrieval device.

FIG. 4 is a flowchart illustrating an example of an operation of the retrieval device.

FIG. 5 is a diagram illustrating an example of retrieval target data which is stored in a data storage unit.

FIG. 6 is a diagram illustrating an example of tokens and inverted indexes which are obtained by a first search method (search A).

FIG. 7 is a diagram illustrating an example of tokens and inverted indexes which are obtained by a second search method (search B).

FIG. 8 is a diagram illustrating an example of a search query.

FIG. 9 is a diagram illustrating an example of the degree of fitness for each piece of the retrieval target data.

FIG. 10 is a diagram illustrating an example of an expanded search query.

FIG. 11 is a diagram illustrating an example of a policy determination model.

FIG. 12 is a diagram illustrating an example of a first query expansion method (query expansion C).

FIG. 13 is a diagram illustrating an example of a second query expansion method (query expansion D).

FIG. 14 is a diagram illustrating an example of a hardware configuration of the retrieval device.

### DESCRIPTION OF EMBODIMENTS

Hereinafter, an embodiment of the present invention will be described in detail with reference to the accompanying drawings. In the description of the drawings, the same or equivalent components are denoted by the same reference numerals and signs, and thus description thereof will not be repeated.

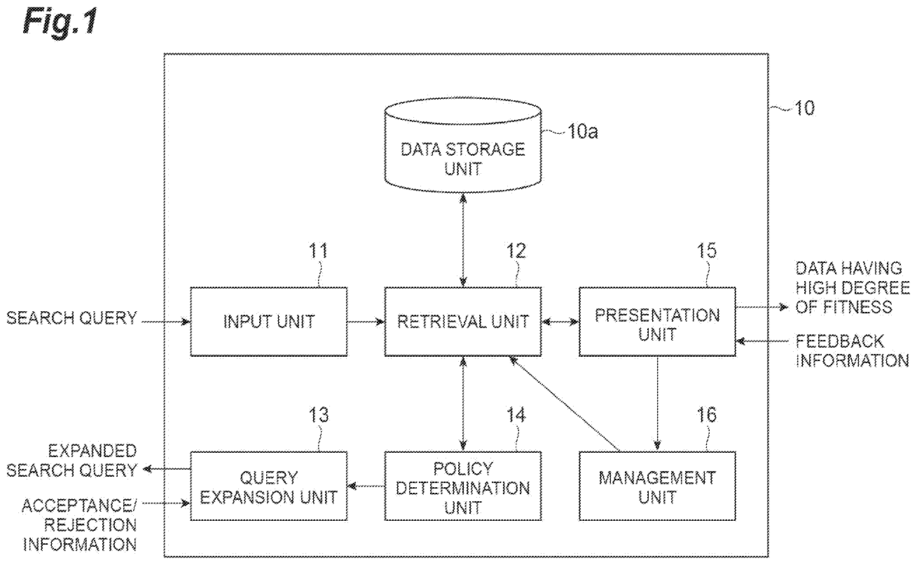

FIG. 1 is a diagram illustrating a functional configuration of a retrieval device 10 according to an embodiment. The retrieval device 10 is a device that receives a search request from a user, retrieves data that matches the user's intention, and presents the search result to the user.

The user is a main subject who requests a search process from the retrieval device 10. Specifically, until a search query is received from the user and then data that matches the user's intention is found (or the user interrupts a search task), the retrieval device 10 is configured to repeat a process of timely selecting and executing either a process of presenting a search result based on the search query to the user (a first process) or a process of expanding the search query and proposing a search using the expanded search query to the user (a second process).

The retrieval device 10 is constituted by one or more computer devices. The aspect of the retrieval device 10 is not limited to a specific aspect. For example, the retrieval device 10 is a terminal such as a smartphone, a tablet terminal, or a personal computer which is possessed by the user. Alternatively, the retrieval device 10 may be a server device configured to communicate with a terminal (client terminal) as described above and to process a search request from the terminal.

As shown in FIG. 1, the retrieval device 10 includes an input unit 11, a retrieval unit 12, a query expansion unit 13, a policy determination unit 14, a presentation unit 15 (a presentation unit, a receiving unit), a management unit 16, and a data storage unit 10a. A plurality of pieces of retrieval target data to be retrieved are stored in advance in the data storage unit 10a. In the present embodiment, the retrieval target data is text data.

The input unit 11 receives a search query from the user. In the present embodiment, the search query is text data. However, the aspect of input of the search query is not limited to a specific aspect. For example, the search query may be input in the format of text data, or may be input in the format of audio data. For example, in a case where the search query is input in the format of audio data, the input unit 11 may convert the search query into text data by executing a known voice recognition process with respect to the search query.

The retrieval unit 12 calculates the degree of fitness between the search query received by the input unit 11 and each of a plurality of pieces of the retrieval target data prepared in advance (that is, data stored in the data storage unit 10a). The degree of fitness is, for example, a value indicating the degree of similarity between a search query and the retrieval target data. Specific examples of the degree of fitness include term frequency inverse document frequency (tfidf), BM25, cosine similarity, Jacquard coefficient distance, and the like.

The retrieval unit 12 is configured to be able to execute a plurality of (two as an example in the present embodiment) search methods different from each other. Specifically, the retrieval unit 12 has a program for executing a first search method (hereinafter referred to as a “search A”) and a program for executing a second search method (hereinafter referred to as a “search B”). The details of these search methods will be described later.

The query expansion unit 13 generates an expanded search query by adding an expanded query associated with the search query to the search query. Specifically, the query expansion unit 13 generates a search query after expansion (expanded search query) by adding a keyword (expanded query) for complementing the search query which is input by the user. For example, in a case where the search query which is input by the user is “ [symbol] ,” the query expansion unit 13 generates an expanded search query “ [symbol] S I [symbol] ” by adding “S I M [symbol] ” which is a keyword (expanded query) for complementing the search query.

The query expansion unit 13 is configured to be able to execute a plurality of (two as an example in the present embodiment) query expansion methods different from each other. Specifically, the query expansion unit 13 has a program for executing a first query expansion method (hereinafter referred to as “query expansion C”) and a program for executing a second query expansion method (hereinafter referred to as “query expansion D”). The details of these query expansion methods will be described later.

The policy determination unit 14 determines which of a first process (process based on the search A or the search B) and a second process (process based on the query expansion C or the query expansion D) is to be executed on the basis of the degree of fitness for each piece of the retrieval target data which is calculated by the retrieval unit 12.

The first process is a process of presenting the retrieval target data of which the degree of fitness is high (hereinafter also referred to as “data having a high degree of fitness”) to the user. That is, the first process is a process of outputting a search result (that is, data having a high degree of fitness) based on a search query, and is a process which is generally performed in normal information retrieval.

The second process is a process of proposing to the user that the retrieval unit 12 is caused to calculate the degree of fitness for each piece of the retrieval target data using the expanded search query generated by the query expansion unit 13 as a new search query. That is, the second process is a process of proposing a re-search using the expanded search query to the user without presenting a search result based on a search query (query before expansion) to the user. In the present embodiment, the second process includes a process of asking the user whether to accept the expanded search query before re-searching based on the expanded search query.

In a case where it is determined that the first process is executed, the policy determination unit 14 determines which of the plurality of (two in the present embodiment) search methods (search A, search B) is to be executed. In addition, in a case where it is determined that the second process is executed, the policy determination unit 14 determines which of the plurality of (two in the present embodiment) query expansion methods (query expansion C, query expansion D) is to be executed. That is, in the present embodiment, the policy determination unit 14 determines which of the plurality of (four in the present embodiment) policies (search A, search B, query expansion C, query expansion D) is to be executed. In the present embodiment, the policy determination unit 14 determines which policy to execute by using a policy determination model (function) generated by reinforcement learning (machine learning). The details of the policy determination model will be described later.

In a case where it is determined by the policy determination unit 14 that the first process is executed, the presentation unit 15 presents data having a high degree of fitness to the user. The management unit 16 manages the retrieval target data which is presented to the user by the presentation unit 15 as presented data. For example, the management unit 16 adds a flag or the like indicating “presented” to the retrieval target data which is stored in the data storage unit 10a so that the retrieval unit 12 can ascertain whether each piece of the retrieval target data has been presented.

In the present embodiment, the presentation unit 15 also functions as a receiving unit that recieves feedback information indicating whether the presented data is data that matches the user's intention from the user. In a case where the feedback information indicating that the presented data is data that matches the user's intention is obtained, processing performed by the retrieval device 10 (processing of the search query received by the input unit 11) is completed. On the other hand, in a case where feedback information indicating that the presented data is not data that matches the user's intention is obtained, the presented data is excluded from the plurality of pieces of the retrieval target data which are stored in the data storage unit 10a, and then a search process (calculation of the degree of fitness) performed by the retrieval unit 12 is executed again. A policy is determined by the policy determination unit 14 on the basis of the degree of fitness of each piece of the retrieval target data (the retrieval target data excluding the presented data) calculated by the retrieval unit 12 again. As described above, the retrieval device 10 repeats each of the above processes while appropriately determining a policy until the data that matches the user's intention is presented to the user.

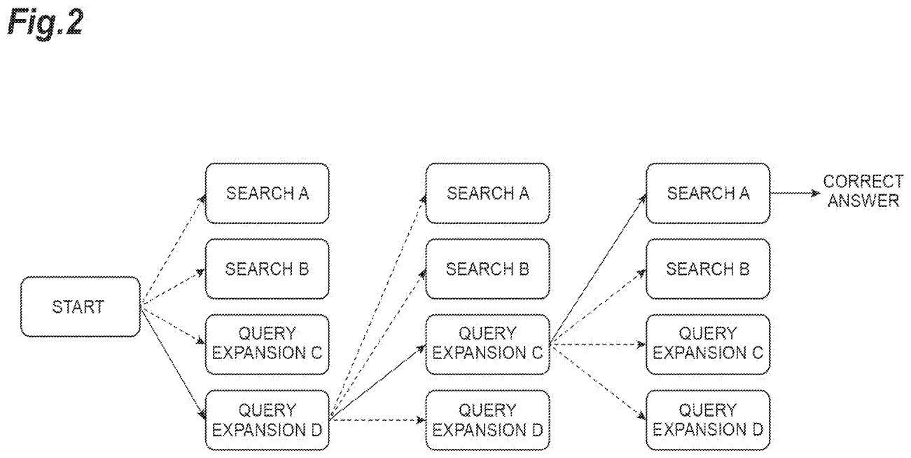

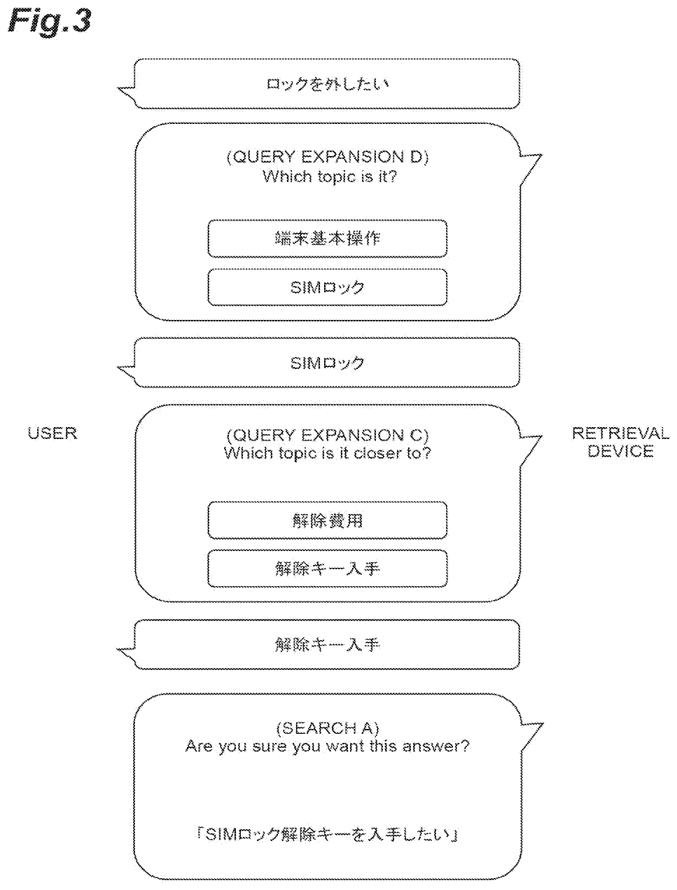

An outline of processing of the retrieval device 10 will be described with reference to FIGS. 2 and 3. FIG. 2 is a diagram schematically illustrating an outline of processing of the retrieval device 10. FIG. 3 is a diagram illustrating an example of a dialogue between the user and the retrieval device 10.

First, the input unit 11 receives a search query (here, “ [symbol] [symbol] ” as an example) (“start” in FIG. 2). Next, the retrieval unit 12 calculates the degree of fitness between the search query and each piece of the retrieval target data. The policy determination unit 14 determines a policy to be executed (search A, search B, query expansion C, query expansion D) on the basis of the degree of fitness for each piece of the retrieval target data. Here, as an example, the query expansion D is selected as a first policy. As a result, two types of expanded search queries generated by the query expansion unit 13 (here, “ [symbol] ” and “S I M [symbol] ” which are expanded queries included in each of the two expanded search queries) are presented to the user.

Thereafter, in response to the user's designation of “S I M [symbol] [symbol] ”, the retrieval unit 12 calculates the degree of fitness for each piece of the retrieval target data using the expanded search query “ [symbol] [symbol] S I M [symbol] .” The policy determination unit 14 determines a policy again on the basis of the degree of fitness for each piece of the retrieval target data. Here, as an example, the query expansion C is selected as a second policy. As a result, two types of expanded search queries generated by the query expansion unit 13 (here, “ [symbol] ” and “ [symbol] ” which are expanded queries included in each of two expanded search queries) are presented to the user.

Thereafter, in response to the user's designation of “ [symbol] [symbol] ,” the retrieval unit 12 calculates the degree of fitness for each piece of the retrieval target data using the expanded search query “ [symbol] [symbol] S I M [symbol] [symbol] .” The policy determination unit 14 determines a policy again on the basis of the degree of fitness for each piece of the retrieval target data. Here, as an example, the search A is selected as a third policy. As a result, the retrieval target data having a high degree of fitness calculated using the expanded search query “S I M [symbol] [symbol] ” is presented to the user by the presentation unit 15. Thereafter, the presentation unit 15 accepts feedback information indicating that the presented data (that is, the retrieval target data “S I M [symbol] [symbol] ”) is data that matches the user's intention from the user, and thus the processing of the retrieval device 10 is completed.

As shown in FIGS. 2 and 3, in the retrieval device 10, the policy determination unit 14 controls whether to present the search result to the user or propose the query expansion to the user in accordance with the state at that point in time (the degree of fitness for each piece of the retrieval target data). By appropriately executing such control, it is possible to suppress the occurrence of useless processing (for example, presentation of useless search results or proposal of unnecessary query expansion) and to improve the efficiency of search.

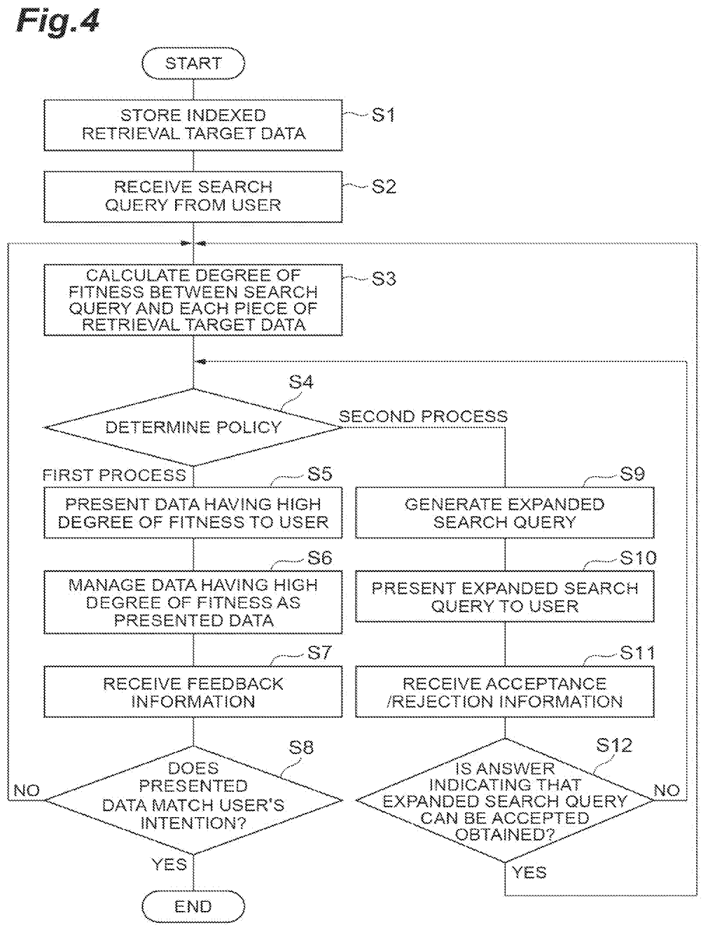

An example of processing the retrieval device 10 will be described in more detail with reference to a flowchart shown in FIG. 4.

In step S1, as a preliminary preparation for the search process, a plurality of pieces of indexed retrieval target data are stored in the data storage unit 10a. In the present embodiment, as an example, each piece of the retrieval target data is a document (text) in which a question sentence and an answer sentence are paired. In the present embodiment, text corresponding to the question sentence in the retrieval target data is a retrieval target. Therefore, in the following description, a portion corresponding to the question sentence in the retrieval target data is simply referred to as retrieval target data.

Inverted indexes are stored in the data storage unit 10a together with original text data indicating the retrieval target data. The inverted index is an index structure in which a document is decomposed into units called tokens and a frequency is associated with each token. In the present embodiment, the search A uses the original form of a noun phrase among the parts of speech obtained by morphological analysis as a token. On the other hand, the search B uses a character string divided by n-gram as a token. However, the types of tokens are not limited to these. For example, the token may be a distributed representation of words generated by Word2Vec, or the like.

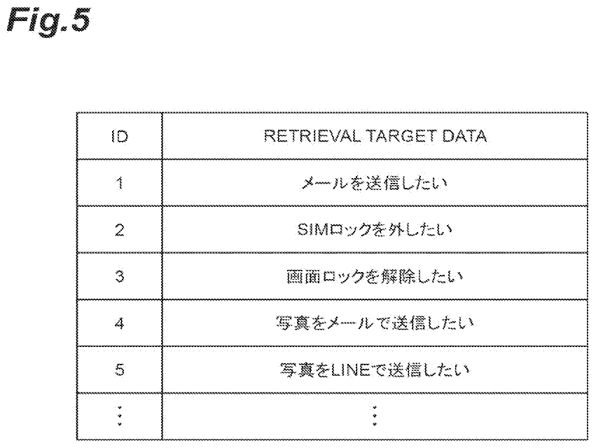

FIG. 5 is a diagram illustrating an example of retrieval target data which is stored in the data storage unit 10a. In this example, it is shown that the retrieval target data of “ID=1” is a question sentence such as “ [symbol] [symbol] .”

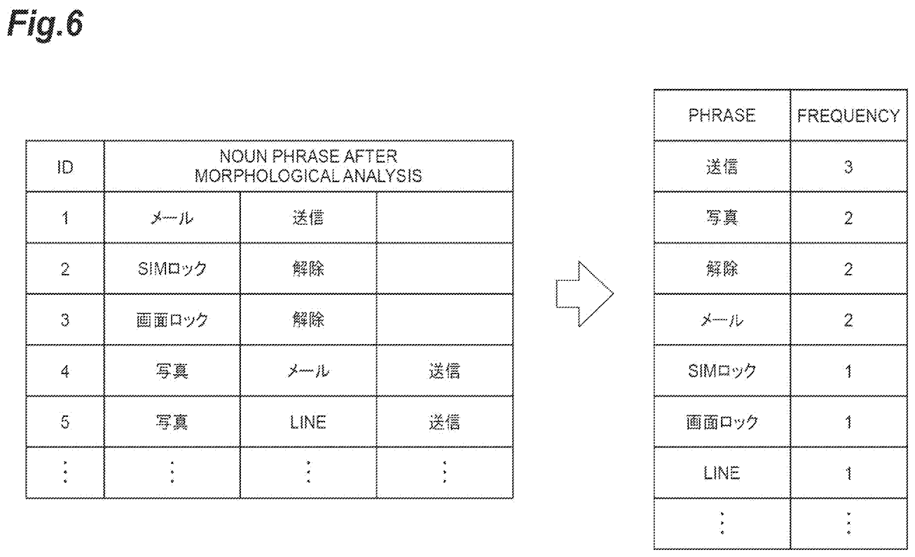

FIG. 6 shows an example of tokens obtained by the search A (noun phrases after morphological analysis) and inverted indexes (a correspondence table between tokens (phases) and frequencies) with respect to the retrieval target data shown in FIG. 5. In this example, the retrieval target data of “ID=1” is converted into two tokens of “ [symbol] ” and “ [symbol] .”

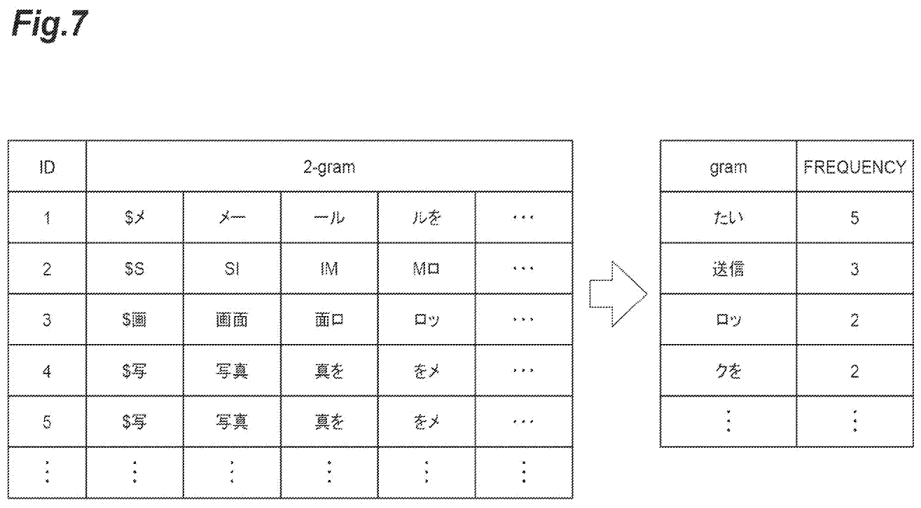

FIG. 7 shows an example tokens obtained by the search B (2-grain) and inverted indexes (a correspondence table between tokens (grain) and frequencies). In this example, the retrieval target data of “ID=1” is converted into a plurality of tokens such as “$ [symbol] ,” “ [symbol] ,”, . . . “ [symbol] $.”

Both the inverted indexes (see FIG. 6) for the search A and the inverted indexes (see FIG. 7) for the search B are stored in the data storage unit 10a. Meanwhile, the process of step S1 may be executed only during initial preparation, and can be omitted in a case where the retrieval target data and the inverted indexes described above are already stored in the data storage unit 10a.

In step S2, the input unit 11 receives a search query from the user. The search query received by the input unit 11 is decomposed into tokens by the retrieval unit 12 in step S3 to be described later, similarly to the process in step S1 (a process of decomposing the retrieval target data into tokens).

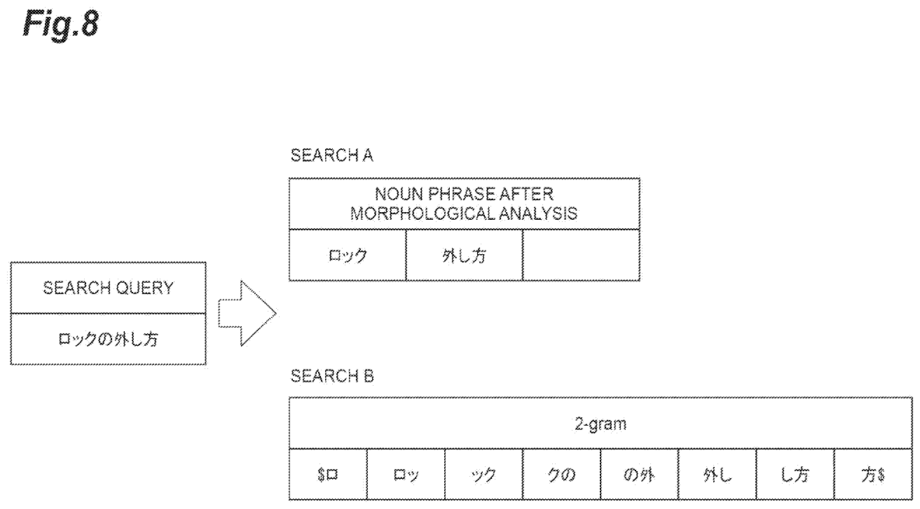

FIG. 8 is a diagram illustrating an example of a search query. In this example, the search query “ [symbol] ” is decomposed into tokens corresponding to the search A (a noun phrase after morphological analysis) and tokens corresponding to the search B (2-gram).

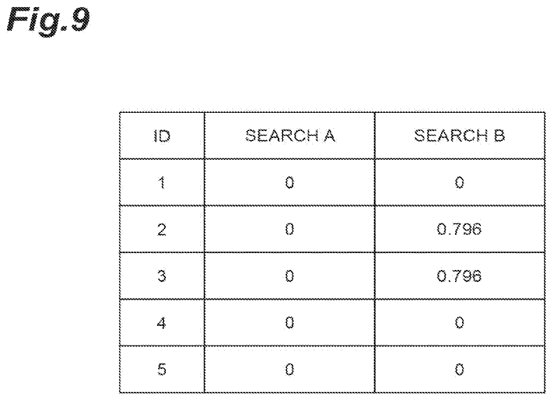

In step S3, the retrieval unit 12 calculates the degree of fitness between the search query and each piece of the retrieval target data which is stored in the data storage unit 10a. As an example, the search A and the search B use tfidf as a measure of the degree of fitness. In the present embodiment, none of tokens (“ [symbol] ,” “ [symbol] ”) decomposed in the search A are registered in the inverted index for the search A (see FIG. 6) stored in the data storage unit 10a. Therefore, as shown in FIG. 9, the degree of fitness of all the retrieval target data which is calculated by the search A is 0. On the other hand, two tokens “ [symbol] ” and “ [symbol] ” among the tokens decomposed in the search B are included in the retrieval target data of “ID=2” and “ID=3.” Therefore, as shown in FIG. 9, the degree of fitness of the retrieval target data of “ID=2” and “ID=3” calculated by the search B is 0.796, and the degree of fitness of other retrieval target data (retrieval target data of “ID=1, 4, 5”) is 0. Meanwhile, the retrieval target data which is managed as presented data by the management unit 16 in step S6 to be described later is excluded from the target of the process of step S3 (calculation of the degree of fitness). For example, the retrieval unit 12 may regard the degree of fitness with respect to the presented data as 0.

In step S4, the policy determination unit 14 determines which of the policies of the search A, the search B, the query expansion C, and the query expansion D is to be executed on the basis of the degree of fitness of each piece of the retrieval target data t which is calculated in step S3. In the present embodiment, as an example, the policy determination unit 14 sets the degree of fitness of the retrieval target data having a high degree of fitness (each of top four pieces of retrieval target data) in each of the search A and the search B as a feature amount (eight-dimensional vector), and inputs the feature amount into a policy determination model (the details of which will be described later). The policy determination unit 14 determines a policy to be adopted on the basis of the output result of the policy determination model (in the present embodiment, a four-dimensional vector consisting of numerical values indicating the desirability of each of the search A, the search B, the query expansion C, and the query expansion D). In a case where the first process (process based on the search A or the search B) is determined as a policy, step S5 is executed. In a case where the second process (process based on the query expansion C or the query expansion D) is determined as a policy, step S9 is executed.

(Case where the First Process is Executed)

In step S5, the presentation unit 15 presents data having a high degree of fitness in a search method determined in step S4 (the search A or the search B in the present embodiment) to the user. The number of pieces of data having a high degree of fitness to be presented may be one or plural.

In step S6, the management unit 16 manages the retrieval target data which is presented to the user by the presentation unit 15 as presented data. For example, the management unit 16 adds a flag or the like indicating “presented” to the retrieval target data which is stored in the data storage unit 10a.

In step S7, the presentation unit 15 receives feedback information indicating whether the presented data is data that matches the user's intention from the user. In a case where the feedback information indicating that the presented data is data that matches the user's intention is obtained (step S8: YES), the retrieval device 10 ends a series of search processes based on the search query received from the user in step S2. On the other hand, in a case where the feedback information indicating that the presented data is not data that matches the user's intention is obtained (step S8: NO), step S3 is executed again. That is, the presented data (data found not to be data desired by the user) is excluded from the retrieval target data, and then the process of step S3 is executed.

(Case where the Second Process is Executed)

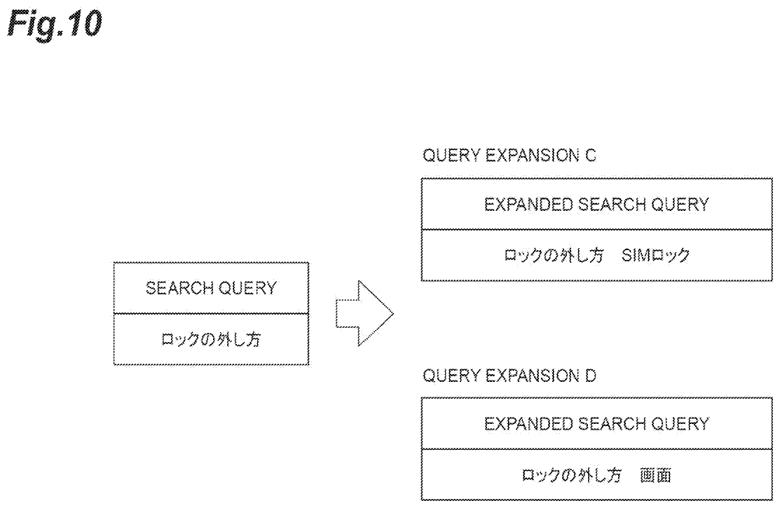

In step S9, the query expansion unit 13 generates an expanded search query using a query expansion method determined in step S4 (the query expansion C or the query expansion D in the present embodiment). FIG. 10 shows an example of an expanded search query generated by each of the query expansion C and the query expansion D. In this example, in a case where the query expansion C is executed, the expanded query “S I M [symbol] ” is added to the original search query “ [symbol] [symbol] ,” so that the expanded search query “ [symbol] S I M [symbol] ” is generated. In addition, in a case where the query expansion D is executed, the expanded query “ [symbol] ” is added to the original search query “ [symbol] ,” so that the expanded search query “ [symbol] [symbol] ” is generated.

In step S10, the query expansion unit 13 presents the expanded search query generated in step S9 (or, as in the example shown in FIG. 3, only an additional candidate query (expanded query) may be used) to the user. That is, the query expansion unit 13 proposes a re-search using the expanded search query to the user.

In step S11, the query expansion unit 13 receives acceptance/rejection information indicating acceptance or rejection of the expanded search query presented to the user in step S10 from the user.

In a case where the acceptance/rejection information indicating that the expanded search query is adopted is obtained (step S12: YES), step S3 is executed again. That is, the process of step S3 is executed using the expanded search query as a new search query. On the other hand, in a case where the acceptance/rejection information indicating that the expanded search query is adopted is not obtained (that is, in a case where a search using the expanded search query presented to the user in step S10 is refused) (step S12: NO), step S4 is executed again as an example. That is, the policy determination unit 14 determines another policy.

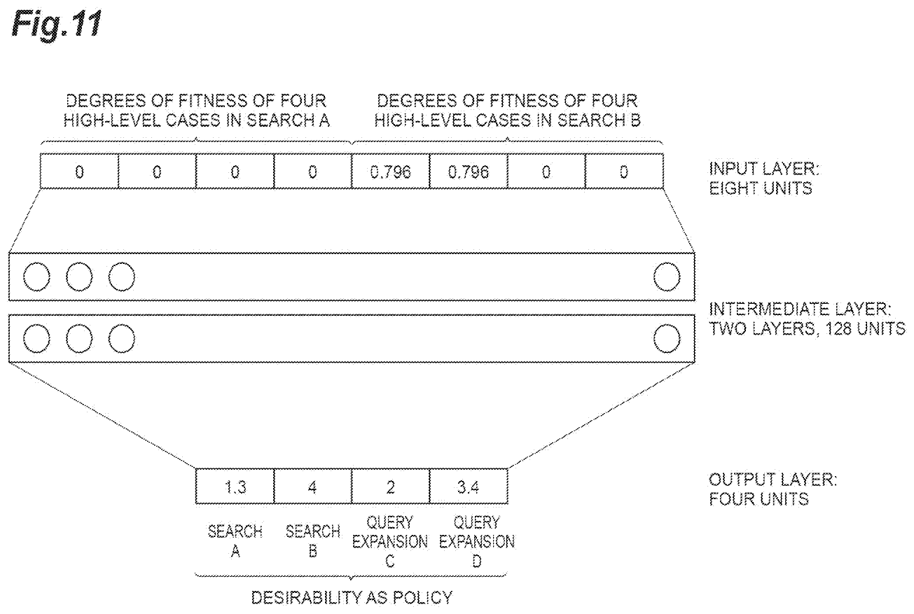

Next, an example of a policy determination model (function) used by the policy determination unit 14 to determine a policy will be described with reference to FIG. 11. The policy determination model is a model which is generated by deep reinforcement learning. In reinforcement learning, a state (current state), a behavior, and a reward are defined. In the present embodiment, as an example, the policy determination model is a model which is generated by performing reinforcement learning with the degree of fitness for each piece of retrieval target data being defined as a state, each policy (that is, the first process (presentation of data having a high degree of fitness in the search A or the search B) and the second process (presentation of the expanded search query generated by the query expansion C or the query expansion D)) being defined as a behavior, and obtainment of data that matches the user's intention (data having a high degree of fitness in the case of the first process, expanded search query in the case of the second process) being defined as a reward.

As shown in FIG. 11, in the present embodiment, the “state” is an eight-dimensional vector in which the degree of fitness of the data having a high degree of fitness obtained by the search A (four pieces of high-level data as an example) and the degree of fitness of the data having a high degree of fitness obtained by the search B (four pieces of high-level data as an example) are combined in an order determined in advance. The state is equivalent to a feature amount which is input to the policy determination model.

The “behavior” has four types, that is, (1) presenting the data having a high degree of fitness in the search A to the user, (2) presenting the data having a high degree of fitness in the search B to the user, (3) presenting the expanded search query generated by the query expansion C to the user, and (4) presenting the expanded search query generated by the query expansion D to the user.

The “reward” is a value that, as a result of the above “behavior,” is “1” in a case where appropriate data is presented to the user and is “0” in other cases. Regarding the above behaviors (1) and (2), the reward “1” is given in a case where the data having a high degree of fitness presented to the user is data that matches the user's intention, and the reward “0” is given in other cases. Regarding the above behaviors (3) and (4), the reward “1” is given in a case where the expanded search query presented to the user is adopted by the user (that is, in a case where the content of the expanded search query matches the user's intention), and the reward “0” is given in other cases.

As shown in FIG. 11, the policy determination model has a multilayer neural network consisting of an input layer, an intermediate layer, and an output layer. The input layer is a portion to which a feature amount (state) is input. In the example of FIG. 9, the degrees of fitness of four high-level cases in the search A are “0, 0, 0, 0,” and the degrees of fitness of four high-level cases in the search B are “0.796, 0.796, 0, 0.” Therefore, in this example, an eight-dimensional vector “0, 0, 0, 0, 0.796, 0.796, 0, 0” obtained by connecting these two results is input to the input layer. Therefore, the input layer is constituted by eight units.

The number of intermediate layers and the number of units are not particularly limited, but as shown in FIG. 11, the intermediate layer may be constituted by, for example, two layers (each layer 128 units).

The output layer is a portion that outputs an output result of the policy determination model. In the present embodiment, the output result is represented by a four-dimensional vector. Therefore, the output layer is constituted by four units. Each value of the four-dimensional vector is a numerical value indicating the degree of desirability of each of the above behaviors (1) to (4). As shown in FIG. 11, for example, in a case where the output result is “1.3, 4, 2, 3.4,” it is indicated that “search B>query expansion D>query expansion C>search A” is a desirable policy in this order. In other words, it is indicated that an expected value for obtaining data that matches the user's intention is high in the above order.

As a specific method for learning the policy determination model, a known algorithm such as, for example, A3C can be used. For example, while the processes of steps S3 to S12 shown in FIG. 2 are repeatedly executed until the retrieval target data that matches the user's intention is finally presented to the user, the reward of each behavior is set on the basis of the feedback information from the user (step S7) and the acceptance/rejection information (step S11), and reinforcement learning is performed using an algorithm such as A3C, so that the internal parameters of the policy determination model (function) are corrected. A policy determination model serving as a learned model is obtained by repeating such reinforcement learning and converging the parameters.

However, the policy determination model does not necessarily have to be generated by reinforcement learning. That is, the policy determination model does not necessarily have to have a multilayer neural network, and may be a function of projecting an output Y indicating which policy is to be executed with respect to some kind of input X. For example, the policy determination model may be a rule-based function. For example, the policy determination model may determine a policy on the basis of <Rules> shown below.

### <Rules>

(A) In a case where the degree of fitness a of the retrieval target data having the maximum degree of fitness in the search A is equal to or higher than a first threshold (for example, 0.5), the search A is adopted.

(B) In a case where the degree of fitness b of the retrieval target data having the maximum degree of fitness in the search B is equal to or higher than a second threshold (for example, 0.5) without satisfying the above (A), the search B is adopted.

(C) In a case where the relation of “the degree of fitness a>the degree of fitness b” is established without satisfying the above (A) or (B), the query expansion C is adopted.

(D) In a case where none of the above (A) to (C) is satisfied, the query expansion D is adopted.

In the example of FIG. 9, since the maximum degree of fitness in the search A is 0 (less than the first threshold) and the maximum degree of fitness in the search B is 0.796 (equal to or higher than the second threshold), the search B is adopted in a case where the policy determination model based on the above rules is used.

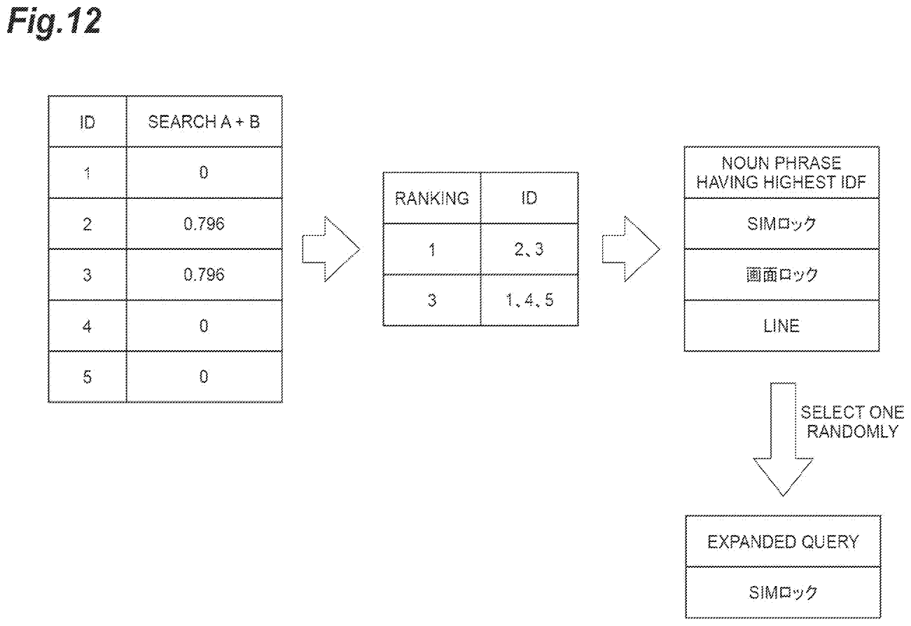

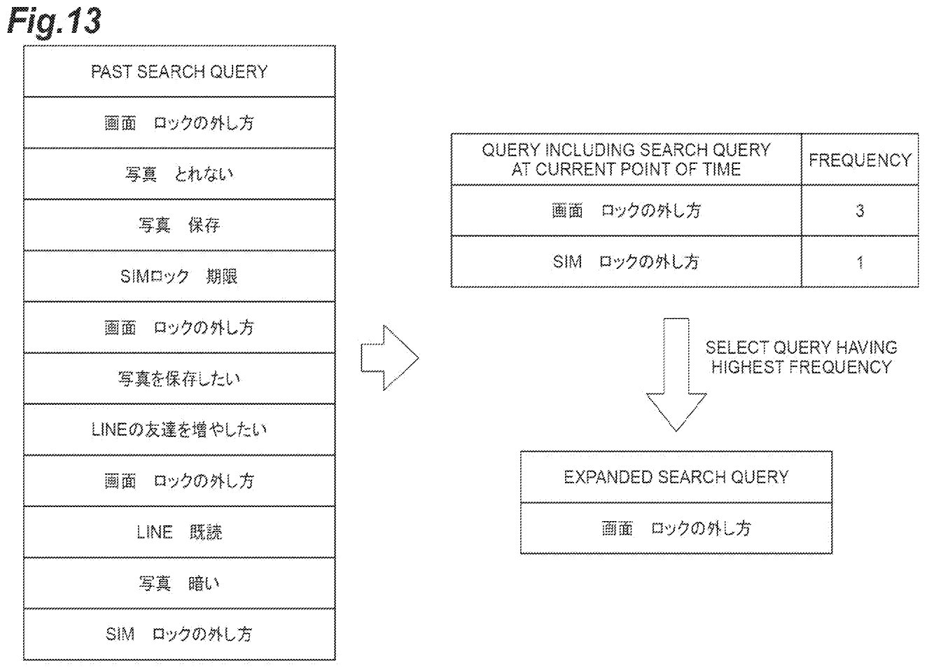

Next, an example of the query expansion C and the query expansion D will be described with reference to FIGS. 12 and 13. FIG. 12 is a diagram illustrating an example of the query expansion C, and FIG. 13 is a diagram illustrating an example of the query expansion D.

As shown in FIG. 12, the query expansion C is a method of extracting the original form of a noun phrase having a highest score of inverse document frequency (IDF) from N pieces (here, as an example, N is 3) of high-level data of the sum of the degrees of fitness in the search A and the search B. As shown in FIG. 12, in the example of FIG. 9, the sum of the degrees of fitness of each piece of retrieval target data from “ID=1” to “ID=5” is, 0, 0.796, 0.796, 0, 0. That is, the retrieval target data of “ID=2, 3” is ranked first at the same rate, and the retrieval target data of “ID=1, 4, 5” is ranked third at the same rate. The noun phrases (noun phrases having a lowest frequency) which are included in these top three ranked retrieval target data and have a highest score of IDF are “S I M [symbol] ,” “ [symbol] ,” and “L I N E” with “frequency=1.” In the query expansion C, for example, one phrase is randomly selected from these noun phrases. As a result, in a case where “S I M [symbol] ” is selected as an expanded query, the expanded search query “ [symbol] [symbol] S I M [symbol] ” is generated as shown in FIG. 10.

As shown in FIG. 13, the query expansion D is a method of extracting words that frequently co-occur with a query from the past search query and proposing correction of the query. The past search query is stored in a log database (not shown) included in the retrieval device 10, for example, as a search log. In this case, the query expansion unit 13 can execute the query expansion based on the query expansion D by referring to the log database. The query expansion D refers to the past search query, selects one word that frequently co-occurs with the search query at the current point of time, and adds the word to the search query at the current point of time. In the example of FIG. 13, the frequency of “ [symbol] [symbol] ” including “ [symbol] [symbol] ” is highest in the past search query. Therefore, as shown in FIG. 10, the expanded search query “ [symbol] [symbol] ” is generated by “ [symbol] ” being added as an expanded query.

In the retrieval device 10 described above, which of the first process of presenting retrieval target data having a high degree of fitness with the search query to the user and the second process of proposing to the user a re-search performed by the retrieval unit 12 using the expanded search query generated by the query expansion unit 13 is to be executed is determined on the basis of the degree of fitness for each piece of the retrieval target data which is obtained at this point of time. In the present embodiment, as an example, the policy determination unit 14 determines a policy on the basis of the degrees of fitness of a predetermined number (four in the present embodiment) of pieces of the retrieval target data having a high degree of fitness in each of the search A and the search B. Therefore, according to the retrieval device 10, by appropriately switching between presenting a search result at the current point of time to the user and performing the query expansion to perform a re-search, it is possible to suppress useless processing (for example, presentation of search results that do not match the user's intention or proposal of unnecessary query expansion) and to improve the efficiency of search. As a result, the expected value of the number of steps (presentation of search results or query expansion) required to present the retrieval target data which is desired by the user to the user can be reduced as much as possible. For example, in the example of FIG. 2, the retrieval target data which is desired by the user can be presented to the user through three steps.

In addition, as described above, the policy determination unit 14 determines which of the first process and the second process is to be executed on the basis of the degrees of fitness of a predetermined number of pieces of the retrieval target data having a high degree of fitness. In the present embodiment, as an example, the policy determination unit 14 determines which of the first process and the second process is to be executed on the basis of the degrees of fitness of top four pieces of the retrieval target data in the search A and the degrees of fitness of top four pieces of the retrieval target data in the search B (see FIG. 11). In this way, by focusing on the degree of fitness of the retrieval target data having a high degree of fitness, it is possible to more accurately determine whether to present the search result to the user through the first process or whether to propose a re-search based on the expanded search query (that is, to perform a search having an improvement in the degree of accuracy through the query expansion) through the second process. For example, in a case where the degree of fitness of the retrieval target data having a high degree of fitness is low as a whole, it is determined that there is a high possibility of the retrieval target data not being data desired by the user, and the second process can be selected. In addition, even in a case where the degree of fitness of the retrieval target data having a high degree of fitness is high as a whole, it is determined that there is a high possibility of the data desired by the user having not been narrowed down at this point of time, and the second process can be selected. In addition, in a case where the degree of fitness of specific retrieval target data is higher than that of other data, it is determined that there is a high possibility of the specific retrieval target data being data desired by the user, and execution of the first process can be selected. Meanwhile, in a case where the policy determination model which is a reinforcement learning model is used as in the present embodiment, the portion where the above determination process is performed is black-boxed as parameters inside the model. However, by focusing on the degree of fitness of the retrieval target data having a high degree of fitness, it is considered that the parameters can be trained so that calculation equivalent to the above determination process can be executed. In addition, in a case where a rule-based function as described above is used instead of the reinforcement learning model, a rule equivalent to the above determination process can be constructed by focusing on the degree of fitness of the retrieval target data having a high degree of fitness.

In addition, the policy determination unit 14 determines which of the first process and the second process is to be executed by using the above-described policy determination model. Here, the policy determination model is a model generated by performing reinforcement learning with the degree of fitness for each piece of the retrieval target data being defined as a state, the first process (presentation of the data having a high degree of fitness in the search A or the search B) and the second process (presentation of the expanded search query generated by the query expansion C or the query expansion D) being defined as a behavior, and obtainment of data that matches the user's intention being defined as a reward. In addition, the policy determination model inputs the degree of fitness for each piece of the retrieval target data and outputs a value indicating which of the first process and the second process is to be executed. The accuracy of policy determination can be improved by using the policy determination model serving as the reinforcement learning model as described above and repeatedly executing the search process of the retrieval device 10. Meanwhile, as described above, as the policy determination model, a rule-based function can also be used instead of such a reinforcement learning model. However, for example, as the number of search methods that can be used in the first process and the number of query expansion methods that can be used in the second process become larger, the rule becomes more complicated, which makes it difficult to create a rule-based and appropriate function. On the other hand, in a case where the reinforcement learning model as described above is used, a portion corresponding to such as a rule can be black-boxed, and thus it is possible to avoid the above problem.

In addition, the retrieval unit 12 is configured to be able to execute a plurality of search methods (the search A and the search B as an example in the present embodiment) different from each other. in a case where it is determined that the first process is executed, the policy determination unit 14 determines which of the plurality of search methods is to be executed. According to the above configuration, in a case where the first process is executed, a search result having a high possibility of matching the user's intention among the search results of the plurality of search methods can be presented to the user.

In addition, the retrieval unit 12 calculates the degree of fitness for each piece of the retrieval target data with respect to each of the plurality of search methods. In the present embodiment, the retrieval unit 12 calculates the degree of fitness for each piece of the retrieval target data with respect to each of the search A and the search B (see FIG. 9).

The policy determination unit 14 then determines which of the first process and the second process is to be executed on the basis of the degree of fitness for each piece of the retrieval target data with respect to each of the plurality of search methods. According to the above configuration, in a case where the retrieval unit 12 can execute the plurality of search methods, a more appropriate policy can be determined compared with a case where only the degree of fitness of a single search method is considered, and thus it is possible to expect an effective improvement in the efficiency of search.

In addition, the query expansion unit 13 is configured to be able to execute a plurality of query expansion methods different from each other (the query expansion C and the query expansion D as an example in the present embodiment). In a case where it is determined that the second process is executed, the policy determination unit 14 determines which of the plurality of query expansion methods is to be executed. According to the above configuration, in a case where the second process is executed, an expanded search query having a high possibility of matching the user's intention among the expanded search queries generated using the plurality of query expansion methods can be proposed to the user.

In addition, in a case where it is determined by the policy determination unit 14 that the first process is executed, the presentation unit 15 presents the data having a high degree of fitness to the user. In addition, the management unit 16 manages the retrieval target data (data having a high degree of fitness) presented to the user by the presentation unit 15 as presented data. In addition, the presentation unit 15 receives feedback information indicating whether the presented data is data that matches the user's intention from the user. In a case where the presentation unit 15 receives the feedback information indicating that the presented data is not data that matches the user's intention, the retrieval unit 12 excludes the presented data from the plurality of pieces of the retrieval target data and calculates the degree of fitness for each piece of the retrieval target data. According to the above configuration, the search process (mainly the process performed by the retrieval unit 12, the query expansion unit 13, and the policy determination unit 14) can be repeatedly executed until the retrieval target data which is desired by the user is obtained in accordance with the feedback information from the user.

Meanwhile, in the above embodiment, the retrieval unit 12 is configured to be able to execute two search methods (the search A and the search B), but the retrieval unit 12 may be configured to be able to execute only one search method, or may be configured to be able to execute three or more search methods. In addition, the query expansion unit 13 is configured to be able to execute two query expansion methods (the query expansion C and the query expansion D), but the query expansion unit 13 may be configured to be able to execute only one query expansion method, or may be configured to be able to execute three or more query expansion methods.

In addition, in the second process (proposal of the expanded search query), the query expansion unit 13 may prompt the user to select an expanded search query to be used from a plurality of expanded search queries (or expanded queries) as illustrated in FIG. 3, or may present only one expanded search query (or expanded query) to the user and prompt the user to answer whether the expanded search query is adopted as illustrated in FIG. 10.

The block diagrams used in the description of the embodiment show blocks in units of functions. These functional blocks (components) are realized in any combination of at least one of hardware and software. Further, a method of realizing each functional block is not particularly limited. That is, each functional block may be realized using one physically or logically coupled device, or may be realized by connecting two or more physically or logically separated devices directly or indirectly (for example, using a wired scheme, a wireless scheme, or the like) and using such a plurality of devices. The functional block may be realized by combining the one device or the plurality of devices with software.

The functions include judging, deciding, determining, calculating, computing, processing, deriving, investigating, searching, confirming, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, or the like, but not limited thereto.

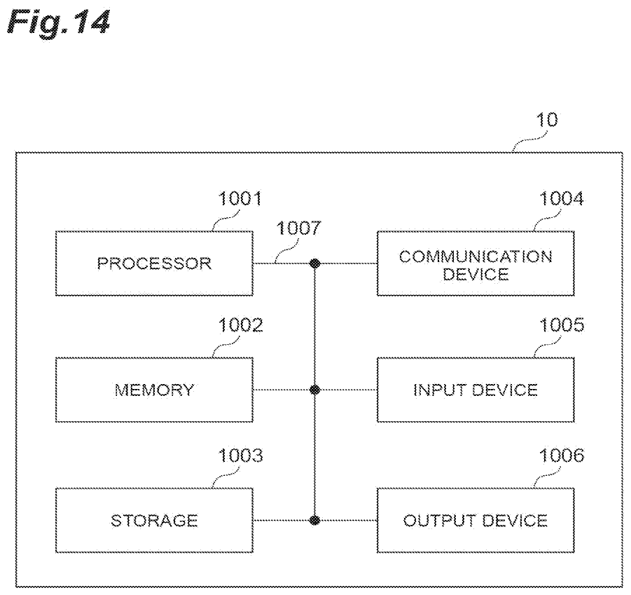

For example, the retrieval device 10 according to an embodiment of the present invention may function as a computer that performs a processing of the present disclosure. FIG. 14 is a diagram illustrating an example of a hardware configuration of the retrieval device 10 according to the embodiment of the present disclosure. The retrieval device 10 described above may be physically configured as a computer device including a processor 1001, a memory 1002, a storage 1003, a communication device 1004, an input device 1005, an output device 1006, a bus 1007, and the like.

In the following description, the term “device” can be referred to as a circuit, a device, a unit, or the like. The hardware configuration of the retrieval device 10 may include one or a plurality of devices illustrated in FIG. 14, or may be configured without including some of the devices.

Each function in the retrieval device 10 is realized by loading predetermined software (a program) into hardware such as the processor 1001 or the memory 1002 so that the processor 1001 performs computation to control communication that is performed by the communication device 1004 or control at least one of reading and writing of data in the memory 1002 and the storage 1003.

The processor 1001, for example, operates an operating system to control the entire computer. The processor 1001 may be configured as a central processing unit (CPU) including an interface with peripheral devices, a control device, a computation device, a register, and the like.

Further, the processor 1001 reads a program (program code), a software module, data, or the like from at one of the storage 1003 and the communication device 1004 into the memory 1002 and executes various processes according to the program, the software module, the data, or the like. As the program, a program for causing the computer to execute at least some of the operations described in the above-described embodiment may be used. For example, the policy determination unit 14 may be realized by a control program that is stored in the memory 1002 and operated on the processor 1001, and other functional blocks may be realized similarly. Although the case in which the various processes described above are executed by one processor 1001 has been described, the processes may be executed simultaneously or sequentially by two or more processors 1001. The processor 1001 may be realized using one or more chips. The program may be transmitted from a network via an electric communication line.

The memory 1002 is a computer-readable recording medium and may be configured of, for example, at least one of a read only memory (ROM), an erasable programmable ROM (EPROM), an electrically erasable programmable ROM (EEPROM), and a random access memory (RAM). The memory 1002 may be referred to as a register, a cache, a main memory (a main storage device), or the like. The memory 1002 can store an executable program (program code), software modules, and the like in order to implement the communication control method according to the embodiment of the present disclosure.

The storage 1003 is a computer-readable recording medium and may also be configured of, for example, at least one of an optical disc such as a compact disc ROM (CD-ROM), a hard disk drive, a flexible disc, a magneto-optical disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The storage medium described above may be, for example, a database including at least one of the memory 1002 and the storage 1003, a server, or another appropriate medium.

The communication device 1004 is hardware (a transmission and reception device) for performing communication between computers via at least one of a wired network and a wireless network and is also referred to as a network device, a network controller, a network card, or a communication module, for example.

The input device 1005 is an input device (for example, a keyboard, a mouse, a microphone, a switch, a button, or a sensor) that receives an input from the outside. The output device 1006 is an output device (for example, a display, a speaker, or an LED lamp) that performs output to the outside. The input device 1005 and the output device 1006 may have an integrated configuration (for example, a touch panel).

Further, the respective devices such as the processor 1001 and the memory 1002 are connected by the bus 1007 for information communication. The bus 1007 may be configured using a single bus or may be configured using buses different between the devices.

Further, the retrieval device 10 may include hardware such as a microprocessor, a digital signal processor (DSP), an application specific integrated circuit (ASIC), a programmable logic device (PLD), or a field programmable gate array (FPGA), and some or all of the functional blocks may be realized by the hardware. For example, the processor 1001 may be implemented by at least one of these pieces of hardware.

Although the present embodiment has been described in detail above, it is apparent to those skilled in the art that the present embodiment is not limited to the embodiments described in the present disclosure.

The present embodiment can be implemented as a modification and change aspect without departing from the spirit and scope of the present invention determined by description of the claims. Accordingly, the description of the present disclosure is intended for the purpose of illustration and does not have any restrictive meaning with respect to the present embodiment.

A process procedure, a sequence, a flowchart, and the like in each aspect/embodiment described in the present disclosure may be in a different order unless inconsistency arises. For example, for the method described in the present disclosure, elements of various steps are presented in an exemplified order, and the elements are not limited to the presented specific order.

Input or output information or the like may be stored in a specific place (for example, a memory) or may be managed in a management table. Information or the like to be input or output can be overwritten, updated, or additionally written. Output information or the like may be deleted. Input information or the like may be transmitted to another device.

A determination may be performed using a value (0 or 1) represented by one bit, may be performed using a Boolean value (true or false), or may be performed through a numerical value comparison (for example, comparison with a predetermined value).

Each aspect/embodiment described in the present disclosure may be used alone, may be used in combination, or may be used by being switched according to the execution. Further, a notification of predetermined information (for example, a notification of “being X”) is not limited to be made explicitly, and may be made implicitly (for example, a notification of the predetermined information is not made).

Software should be construed widely so that the software means an instruction, an instruction set, a code, a code segment, a program code, a program, a sub-program, a software module, an application, a software application, a software package, a routine, a sub-routine, an object, an executable file, a thread of execution, a procedure, a function, and the like regardless whether the software is called software, firmware, middleware, microcode, or hardware description language or called another name.

Further, software, instructions, information, and the like may be transmitted and received via a transmission medium. For example, when software is transmitted from a website, a server, or another remote source using wired technology (a coaxial cable, an optical fiber cable, a twisted pair, a digital subscriber line (DSL), or the like) and wireless technology (infrared rays, microwaves, or the like), at least one of the wired technology and the wireless technology is included in a definition of the transmission medium.

The information, signals, and the like described in the present disclosure may be represented using any of various different technologies. For example, data, an instruction, a command, information, a signal, a bit, a symbol, a chip, and the like that can be referred to throughout the above description may be represented by a voltage, a current, an electromagnetic wave, a magnetic field or a magnetic particle, an optical field or a photon, or an arbitrary combination of them.

Further, the information, parameters, and the like described in the present disclosure may be expressed using an absolute value, may be expressed using a relative value from a predetermined value, or may be expressed using another corresponding information.

Names used for the above-described parameters are not limited names in any way. Further, equations or the like using these parameters may be different from those explicitly disclosed in the present disclosure. Since various information elements can be identified by any suitable names, the various names assigned to these various information elements are not limited names in any way.

The description “based on” used in the present disclosure does not mean “based only on” unless otherwise noted. In other words, the description “based on” means both of “based only on” and “based at least on”.

Any reference to elements using designations such as “first,” “second,” or the like used in the present disclosure does not generally limit the quantity or order of those elements. These designations may be used in the present disclosure as a convenient way for distinguishing between two or more elements. Thus, the reference to the first and second elements does not mean that only two elements can be adopted there or that the first element has to precede the second element in some way.

When “include”, “including” and transformation of them are used in the present disclosure, these terms are intended to be comprehensive like the term “comprising”. Further, the term “or” used in the present disclosure is intended not to be exclusive OR.

In the present disclosure, for example, when articles such as a, an, and the in English are added by translation, the present disclosure may include that nouns following these articles are plural.

In the present disclosure, a sentence “A and B are different” may mean that “A and B are different from each other”. The sentence may mean that “each of A and B is different from C”. Terms such as “separate”, “coupled”, and the like may also be interpreted, similar to “different”.

### REFERENCE SIGNS LIST

10 Retrieval device
10a Data storage unit
11 Input unit
12 Retrieval unit
13 Query expansion unit
14 Policy determination unit
15 Presentation unit (acceptance unit)
16 Management unit

1: A retrieval device comprising:
an input unit configured to receive a search query from a user;
a retrieval unit configured to calculate a degree of fitness between the search query and each of a plurality of pieces of retrieval target data to be retrieved which are prepared in advance;
a query expansion unit configured to generate an expanded search query by adding an expanded query associated with the search query to the search query; and
a policy determination unit configured to determine which of a first process and a second process is to be executed on the basis of the degree of fitness for each piece of the retrieval target data which is calculated by the retrieval unit, wherein the first process is presenting the retrieval target data having a high degree of fitness to the user, and the second process is proposing to the user that the retrieval unit is caused to calculate the degree of fitness for each piece of the retrieval target data using the expanded search query as a new search query.

2: The retrieval device according to claim 1,
wherein the policy determination unit is configured to determine which of the first process and the second process is to be executed on the basis of the degrees of fitness of a predetermined number of pieces of the retrieval target data having a high degree of fitness.

3: The retrieval device according to claim 1,
wherein the policy determination unit is configured to determine which of the first process and the second process is to be executed by using a policy determination model generated by performing reinforcement learning with the degree of fitness for each piece of the retrieval target data being defined as a state, the first process and the second process being defined as a behavior, and obtainment of data that matches the user's intention being defined as a reward, the policy determination model inputting the degree of fitness for each piece of the retrieval target data and outputting a value indicating which of the first process and the second process is to be executed.

4: The retrieval device according to claim 1,
wherein the retrieval unit is configured to be able to execute a plurality of search methods different from each other, and
the policy determination unit is configured to determine which of the plurality of search methods is to be executed in a case where it is determined that the first process is executed.

5: The retrieval device according to claim 4,
wherein the retrieval unit is configured to calculate the degree of fitness for each piece of the retrieval target data with respect to each of the plurality of search methods, and
the policy determination unit is configured to determine which of the first process and the second process is to be executed on the basis of the degree of fitness for each piece of the retrieval target data with respect to each of the plurality of search methods.

6: The retrieval device according to claim 1,
wherein the query expansion unit is configured to be able to execute a plurality of query expansion methods different from each other, and
the policy determination unit is configured to determine which of the plurality of query expansion methods is to be executed in a case where it is determined that the second process is executed.

7: The retrieval device according to claim 1, further comprising:
a presentation unit configured to present the retrieval target data having a high degree of fitness to the user in a case where it is determined by the policy determination unit that the first process is executed;
a management unit configured to manage the retrieval target data which is presented to the user by the presentation unit as a presented data; and
a receiving unit configured to receive feedback information indicating whether the presented data is data that matches the user's intention from the user,
wherein, in a case where the receiving unit receives the feedback information indicating that the presented data is not data that matches the user's intention, the retrieval unit is configured to exclude the presented data from the plurality of pieces of the retrieval target data and calculate the degree of fitness for each piece of the retrieval target data.
